(19) United States
(12) Patent Application Publication
(10) Pub. No.: US 2008/0180738 A1
(43) Pub. Date: Jul. 31, 2008

(54) IMAGE FORMING APPARATUS AND CONTROL METHOD THEREOF

(76) Inventors: Kang Hee Lim, Suwon-si (KR); Jea Hong Park, Suwon-si (KR)

Correspondence Address: STANZIONE & KIM, LLP, 919 18TH STREET, N.W., SUITE 440, WASHINGTON, DC, 20006, US

(21) Appl. No.: 12/019,082

(22) Filed: Jan. 24, 2008

(30) Foreign Application Priority Data
Jan. 29, 2007 (KR) 2007-9111
Jan. 7, 2008 (KR) 2008-1665

(51) Int. Cl. G06F 15/00

(52) U.S. Cl. 358/1.15; 358/452

(57) ABSTRACT

A method of controlling an image forming apparatus connected to at least one server on a network. The method includes receiving an edit command for image data stored in the server from a user, and controlling the image data to be edited according to the edit command.

### CROSS-REFERENCE TO RELATED APPLICATIONS

This application claims the benefit of Korean Patent Application No. 2007-9111, filed on Jan. 29, 2007 and No. 2008-1665, filed on Jan. 7, 2008 in the Korean Intellectual Property Office, the disclosure of which is incorporated herein by reference in its entirety.

### BACKGROUND OF THE INVENTION

1. Field of the Invention

The present general inventive concept relates to an image forming apparatus and a control method thereof, and more particularly to an image forming apparatus, which allows a user to manage image data of a server connected through a network without using a terminal apparatus, and a control method of the image forming apparatus.

2. Description of the Related Art

In general, an image forming apparatus refers to multifunction office equipment for enhancing the functions of an existing copier and the efficiency of office space by adding the functions of a printer, a scanner and the like to a digital type copier.

The aforementioned image forming apparatus may be connected to a server and a terminal apparatus through a network. The image forming apparatus connected to the server on the network immediately transmits image data formed through scanning or the like to the server so that the image data can be stored in the server.

However, since the conventional image forming apparatus as described above has no edition function, a user cannot edit files stored in the server before the user uses the image forming apparatus and the terminal apparatus connected to the server on the network.

Further, if the image data stored in the server are required to be edited, a user must access the server through a terminal apparatus and then edit the image data stored in the server.

However, in a case where erroneous image data are transmitted to the server due to a user's mistake or an abnormal operation of an apparatus, or where image data with no utility value are stored in the server, a user must access the server through the terminal apparatus and then delete the image data stored in the server.

### SUMMARY OF THE INVENTION

The general inventive concept provides an image forming apparatus having an edition function, and a control method of the image forming apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling an image forming apparatus connected to at least one server on a network, the method including: receiving an edit command for image data stored in the server from a user; and controlling the image data to be edited according to the edit command.

The method may further include displaying server identification information to identify the server, and receiving a server selection command to select the server in the operation of receiving the edit command.

In the operation of displaying the information, registration information of the image data stored in the server may further be displayed, and an image selection command to select the image data is further received in the operation of receiving the edit command.

In the operation of displaying the information, an edition permission window to permit an edition of the image data is further displayed.

Further, authentication information to permit an edit of the image data is further received in the operation of receiving the edition command, and the image data of the server is controlled to be edited if the authentication information is identical to reference authentication information in the operation of controlling the image data.

In the operation of controlling the image data, the image data of the server is controlled to be deleted if the edit command relates to deletion of the image data.

The foregoing and/or other aspects and utilities of the present general inventive concept may also be achieved by providing an image forming apparatus including: an input unit to receive an edit command for image data from a user; and a controller to control the image data of the server, which is connected to the image forming apparatus, to be edited according to the edit command.

The image forming apparatus further includes a display unit to display server identification information of identifying the server, and the input unit further receives a server selection command to select the server.

Further, the display unit further displays registration information of the image data stored in the server, and the input unit further receives an image selection command to select the image data.

The input unit further receives authentication information to permit an edit of the image data, and the controller controls the image data of the server to be edited if the authentication information is identical to reference authentication information.

The foregoing and/or other aspects and utilities of the present general inventive concept may also be achieved by providing a method of controlling editing image data in at least one server on a network from an image forming apparatus, including sending an edit command from the image forming apparatus to the at least one server to edit image data stored therein; and controlling the image data to be edited according to the edit command.

In the above method, the sending an edit command can be generated through an input from a user.

### BRIEF DESCRIPTION OF THE DRAWINGS

The above and other aspects and utilities of the present general inventive concept will be more apparent from the following detailed description taken in conjunction with the accompanying drawings, in which:

FIG. 1 is a block diagram of an image forming apparatus according to an embodiment of the present general inventive concept;

FIGS. 2A to 2D illustrate screens, on which an edition menu to edit image data, server identification information, registration information of image data and a deletion confirmation message are displayed, according to the present general inventive concept;

FIG. 3 is a screen illustrating an edit permission window to receive authentication information in order to permit an edit of image data according to the present general inventive concept; and

FIG. 4 is a flowchart illustrating a control process of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

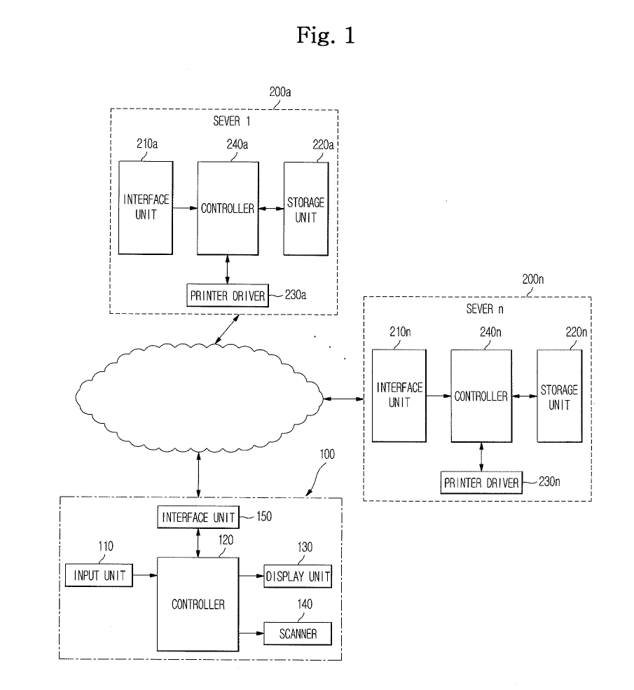

FIG. 1 is a block diagram of an image forming apparatus according to an embodiment of the present general inventive concept. Referring to FIG. 1, the image forming apparatus 100 of this embodiment is connected to servers 200a to 200n, which store image data, through a network. Here, the server may comprise one or more servers.

The image forming apparatus 100 transmits files to the servers 200a to 200n by using methods of FTP (File Transfer Protocol) and SMB (Server Message Block). The FTP refers to a method and program to support exchange of files among computers on the Internet. The SMB refers to a file/printer sharing protocol used in a Windows environment such as Windows 95 or Windows NT.

Hereinafter, elements of the image forming apparatus 100 will be described in detail.

The image forming apparatus 100 can include an input unit 110, a controller 120, a display unit 130, a scanner 140 and an interface unit 150.

The input unit 110 receives a print mode (normal mode or power saving mode), and a control command including a menu, scanning, discharging/selection and the like, and directly receives an edition command of image data from a user. That is, the input unit 110 can receive a deletion command to delete the image data or a transfer command to transfer the image data to another server from the user through a plurality of buttons and a touch screen.

Further, the input unit 110 can receive a server selection command to select the servers 200a to 200n that store image data to be edited, and an image selection command to select the image data to be edited from the image data stored in the servers 200a to 200n.

Furthermore, when editing of the image data is performed, the input unit 110 receives authentication information for editing permission of the image data in order to prevent the image data from being edited by other users.

In addition, the input unit 110 may further receive a search command to search for image data, a scanning command to scan image data, and a printing command to print image data.

The controller 120 controls the image data of the servers 200a to 200n to be edited in response to the edit command of the image data.

That is, if the edit command of the image data directly input by a user is a deletion command, the controller 120 controls the image data of the servers 200a to 200n to be deleted. If the edit command of the image data directly input by the user is a transfer command, the controller 120 controls the image data of the servers 200a to 200n to be transferred from one server to another server.

In more detail, the controller 120 converts the edit command of the image data to an edit command according to protocols preset between the image forming apparatus 100 and the servers 200a to 200n, and then transmits the converted edit command to the servers 200a to 200n, so that the image data can be edited in the servers 200a to 200n.

Conventionally, a user could delete image data registered and stored in the servers 200a to 200n only by using a terminal apparatus connected to the image forming apparatus 100 and the servers 200a to 200n through a network. However, in the embodiments of the present general inventive concept as described herein, the image forming apparatus 100 can directly edit image data according to an edit command of a user without using a terminal apparatus.

Further, if authentication information input at the input unit 110 is registered reference authentication information, the controller 120 controls an editing operation corresponding to the edit command of the image data to be performed, so that the image data can be prevented from being arbitrarily edited by other users without permission.

The display unit 130 displays information on the image forming apparatus 100, and further displays server identification information to identify the servers 200a to 200n, and registration information of the image data stored in the servers.

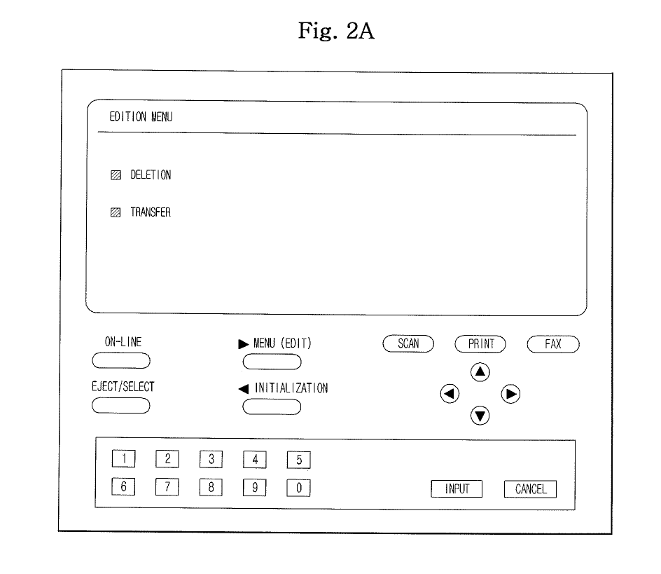

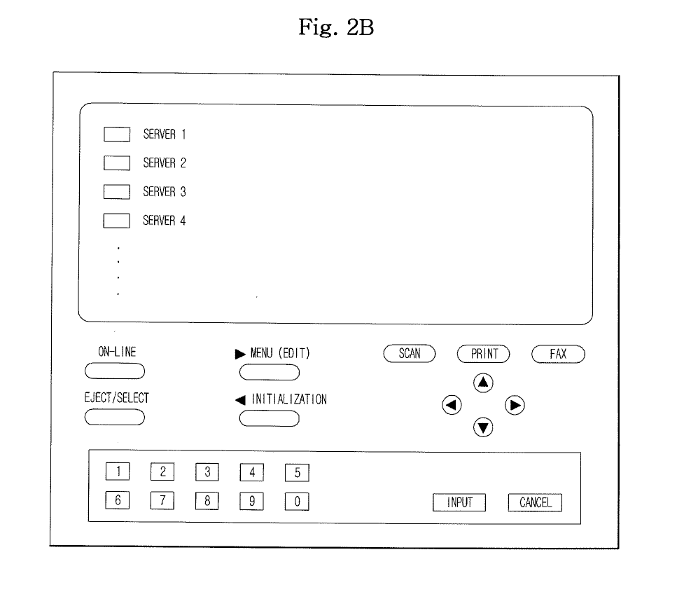

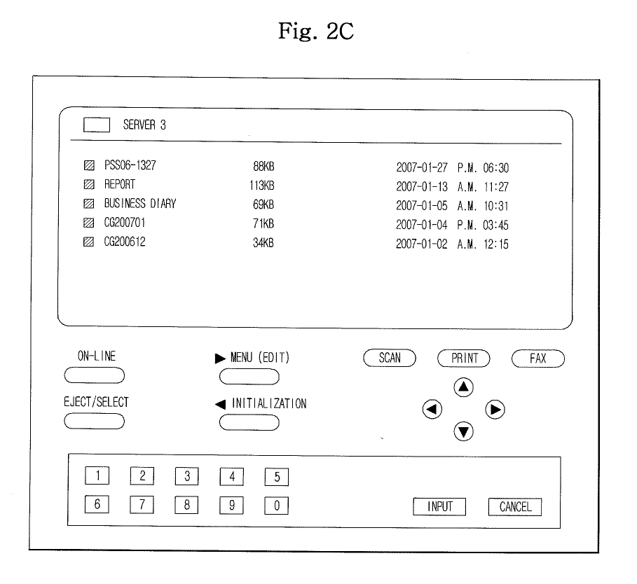

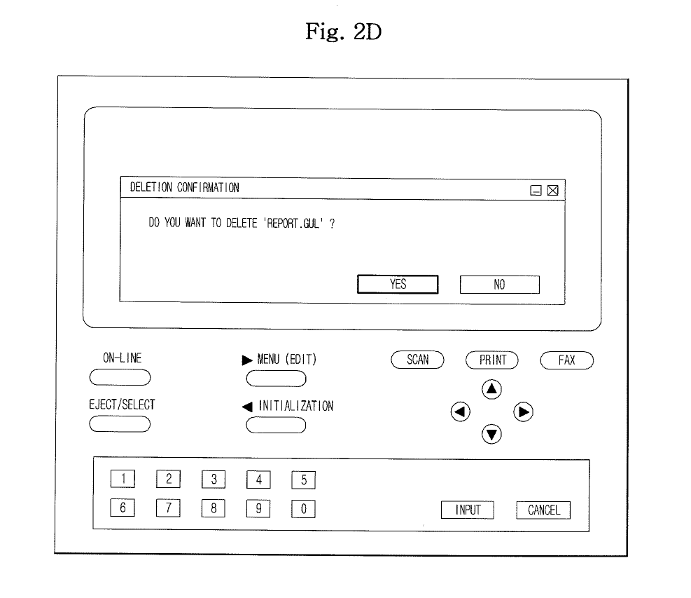

FIGS. 2A to 2D illustrate screens, on which an edit menu to edit image data, server identification information, registration information of image data and a deletion confirmation message are displayed, according to embodiments of the present general inventive concept. As illustrated in FIG. 2A, the display unit 130 displays an edit menu such as deletion and transfer of data if a user selects a menu (edition) key provided on an operation panel of the image forming apparatus 100.

If the user selects deletion as an edit command, the display unit 130 displays the server identification information on the servers 200a to 200n connected to the image forming apparatus 100 through a network as illustrated in FIG. 2B. Here, the server identification information relates to identification information for the servers 200a to 200n, and may be the titles of servers, such as servers 1, 2, 3 and 4, connected to the image forming apparatus 100 through a network.

That is, if the display unit 130 displays the server identification information, the input unit 110 receives a server selection command to select of the servers 200a to 200n from the user.

If a server is selected through the server selection command, the display unit 130 displays registration information of the image data stored in the servers 200a to 200n, as illustrated in FIG. 2C.

More specifically, in a case where the image data to be deleted are data having the name “report” stored in server 3, if the user selects the server 3 on the screen of FIG. 2B, the display unit 130 displays registration information of the image data including the title, capacity and registered date of the image data stored in the server 3, so that the user can select the image data to be deleted.

If the user selects the “report” in the screen of FIG. 2C, the display unit 130 displays a deletion confirmation message such as “do you want to delete report.gul” as illustrated in FIG. 2D. Accordingly, the user can delete the image data after confirming the image data to be deleted.

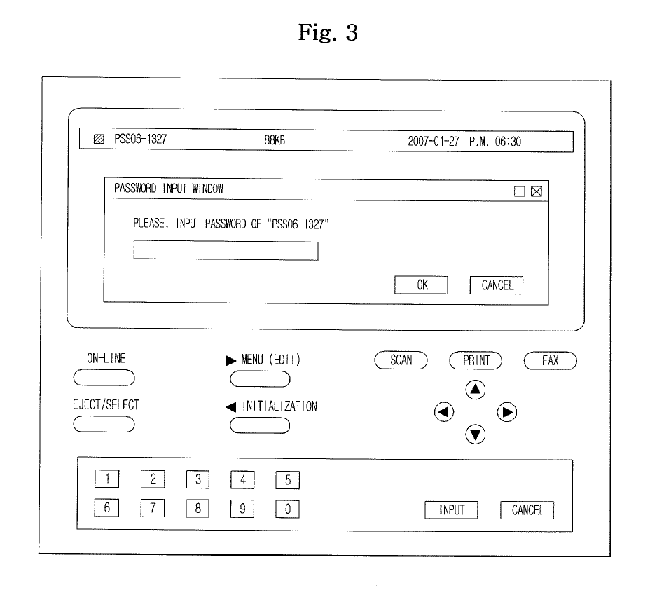

FIG. 3 is a screen illustrating an edit permission window to receive authentication information in order to permit editing of image data according to an embodiment of the present general inventive concept. As illustrated in FIG. 3, the display unit 130 displays the edit permission window in order to permit an edit of the image data, so that the authentication information can be received from a user.

The scanner 140 scans the image data to register and store the scanned image data in the servers 200a to 200n.

In more detail, if a registration command is directly input by a user, the scanner 140 scans the image data such that the scanned image data are registered in the servers 200a to 200n.

Further, the input unit 110 further receives reference authentication information to permit registration of the image data. Accordingly, when the image data is edited later, the image data can be prevented from being arbitrarily edited by other persons through a comparison between the reference authentication information and authentication information input by a user.

The interface unit 150 allows data to be exchanged with the servers 200a to 200n. In more detail, the interface unit 150 transmits an edit command of the image data to the servers 200a to 200n.

The servers 200a to 200n comprises interface units 210a to 210n, storage units 220a to 220n, printer drivers 230a to 230n, and controllers 240a to 240n, respectively.

The interface units 210a to 210n allow data to be exchanged with the image forming apparatus 100, and receive the edit commands of the image data stored in the servers 200a to 200n from the image forming apparatus 100, respectively.

The storage units 220a to 220n store image data, respectively.

The printer drivers 230a to 230n analyze the edit commands of the image data to transmit the analyzed edit commands to the controllers 240a to 240n, respectively.

The controllers 240a to 240n receive the analyzed edit commands to control the image data stored in the storage units 220a to 220n to be edited. That is, if the edit commands of the image data are delete commands, the controllers 240a to 240n control the image data of the servers 200a to 200n to be deleted. Further, if the edit commands of the image data are transfer commands, the controllers 240a to 240n control the image data to be transferred to other servers.

Hereinafter, a control process of the image forming apparatus according to an embodiment of the present general inventive concept will be described.

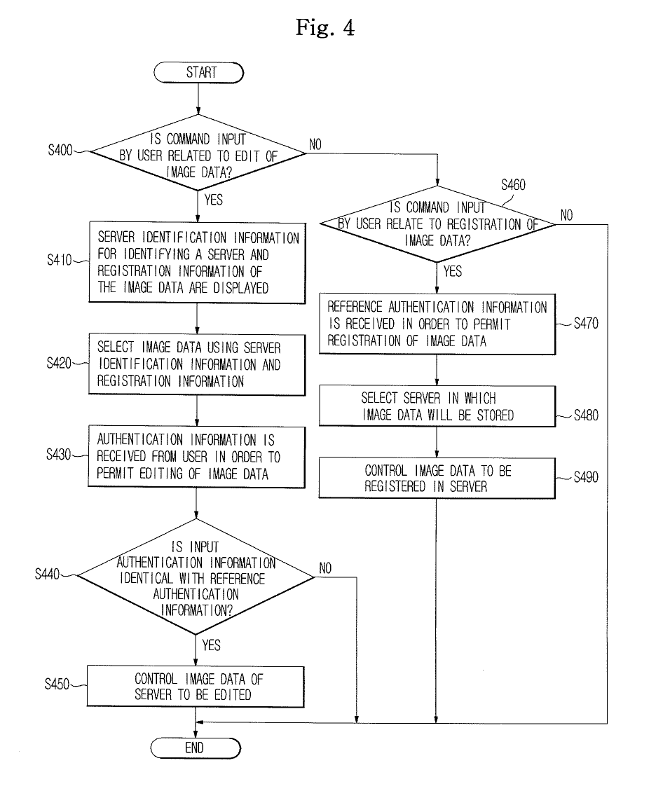

FIG. 4 is a flowchart illustrating a control process of the image forming apparatus according to an embodiment of the present general inventive concept. As illustrated in FIG. 4, it is determined whether a command input by a user relates to an edit of image data (operation S400). In a case where the command relates to an edit, server identification information to identify a server and registration information of the image data are displayed such that the image data can be selected (operation S410). The edit command comprises a delete command to delete the image data or a transfer command to transfer the image data to other servers.

Then, a user selects image data to be edited using the server identification information and the registration information (operation S420).

In more detail, if a delete menu to delete the image data is selected, server identification information is displayed, a server selection command is input by the user, and registration information of image data stored in a server corresponding to the server selection command is further displayed, so that the user can select the image data.

Further, authentication information for editing permission of the image data is received from the user (operation S430). In order to receive the authentication information from the user, the edit permission window for the editing permission of the image data is further displayed as illustrated in FIG. 3.

It is determined whether authentication information input to identify the edit of the image data is identical to reference authentication information that has been preset and registered (operation S440). If the authentication information is identical to the reference authentication information, the image data stored in the server is controlled to be deleted (operation S450).

In a case where the command input by the user does not relate to an edit of the image data in operation 400, it is determined whether the command relates to a registration of the image data (operation S460).

In a case where the command relates to a registration of the image data, reference authentication information is received for registration permission of the image data (operation S470). As described above, the reference authentication information is received before the image data is registered, so that the image data can be prevented from being arbitrarily deleted by other persons through a comparison between the reference authentication information and authentication information input by a user when the image data is edited later.

Then, a server in which the image data is to be stored is selected (operation S480), and the image data is controlled to be registered in the server (operation S490).

According to an image forming apparatus and a control method thereof of the embodiments of the present general inventive concept as described above, the image forming apparatus can directly receive an edit command from a user without using a terminal apparatus, and can edit and manage image data. Consequently, the image data can be edited without using a separate terminal apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling an image forming apparatus connected to at least one server on a network, the method comprising:
receiving an edit command for image data stored in the at least one server from a user; and
controlling the image data to be edited according to the edit command.

2. The method as claimed in claim 1, further comprising:
when the edit command is received, displaying server identification information identifying the at least one server or registration information of the image data stored in the server.

3. The method as claimed in claim 1, wherein, in the operation of receiving the edit command, a server selection command to select the server or an image selection command to select the image data is further received.

4. The method as claimed in claim 2, wherein, in the operation of displaying the information, an edit permission window to permit an edit of the image data is further displayed.

5. The method as claimed in claim 1, wherein authentication information to permit an edit of the image data is further received in the operation of receiving the edit command, and the image data of the server is controlled to be edited if the authentication information is identical to reference authentication information in the operation of controlling the image data.

6. The method as claimed in claim 1, wherein, in the operation of controlling the image data, the image data of the server is controlled to be deleted if the edit command relates to deletion of the image data.

7. An image forming apparatus connected to at least one server on a network, the image forming apparatus comprising:
an input unit to receive an edit command for image data stored in the at least one server from a user; and
a controller to control the image data of the server to be edited according to the edit command.

8. The image forming apparatus as claimed in claim 7, further comprising:
a display unit to display server identification information identifying the at least one server or registration information of the image data stored in the server.

9. The image forming apparatus as claimed in claim 7, wherein the input unit further receives a server selection command to select the server or an image selection command to select the image data.

10. The image forming apparatus as claimed in claim 7, wherein the input unit further receives authentication information to permit an edit of the image data, and the controller controls the image data of the server to be edited if the authentication information is identical to reference authentication information.

11. A method of controlling editing image data in at least one server on a network from an image forming apparatus, the method comprising:
sending an edit command from the image forming apparatus to the at least one server to edit image data stored therein; and
controlling the image data to be edited according to the edit command.

12. The method as claimed in claim 11, wherein the sending an edit command is generated through an input from a user.

13. The method as claimed in claim 11, wherein the edit command includes one of deleting the image data, transferring the image data to another server or altering the image data.
